(19) United States
(12) Patent Application Publication
(10) Pub. No.: US 2012/0222335 A1
(43) Pub. Date: Sep. 6, 2012

(54) DISASSEMBLY OF INTER-FITTING COMPONENTS

(75) Inventors: Mitchell Brian Charlton, Wallsend (AU); Paul Anthony Roberts, Macquarie Hills (AU)

(73) Assignee: Bradken Resources Pty Limited, Mayfield West (AU)

(21) Appl. No.: 13/395,622

(22) PCT Filed: Sep. 13, 2010
(86) PCT No.: PCT/AU10/01186

§ 371 Date: May 23, 2012

(30) Foreign Application Priority Data
Sep. 11, 2009 (AU) 2009904408
Mar. 16, 2010 (AU) 2010901087
Aug. 13, 2010 (AU) 2010903636

(51) Int. Cl. E02F 9/28; B23P 11/00; B25B 27/14

(52) U.S. Cl. 37/452; 29/253; 29/426.5

(57) ABSTRACT

A tool for disassembling an excavation tooth assembly comprising first and second tooth members, the tool comprising:
a body comprising a driven portion and first and second legs, the legs extending generally in a common plane and defining an assembly receiving cavity therebetween, each of the first and second legs comprising a wedge portion adjacent the assembly receiving cavity which tapers toward a distal end of the respective leg, in use the tool being adapted to locate over a join defined between the first and second tooth members such that the wedge portion of the first and second legs locates within the join and wherein in use a force applied to the driven portion is arranged to drive the wedge portion further into the join so as to cause separation of the first and second tooth members in a direction transverse to the movement of the first and second legs.

### FIELD OF THE INVENTION

The present disclosure relates to tools for facilitating the disassembly of components which are fitted together generally in an intimate manner for a period of use and which need to be disassembled for servicing purposes, such as excavation tooth assemblies.

### BACKGROUND OF THE INVENTION

Excavation teeth are provided on the digging edge of various pieces of digging equipment, such as dredging cutter heads, the buckets of front end loaders, etc. Excavation teeth are formed of a number of components, commonly a tooth point and an adapter. The reason why excavation teeth are formed of a number of components is to avoid having to discard the entire tooth when the ground engaging part of the tooth (i.e. the point) is worn or broken.

For mining buckets, for example, excavation points are typically connected to a leading edge of the bucket by way of an adaptor which is secured to the bucket lip. The adapter not only acts as a mounting for the point but also acts to reinforce and strengthen the lip. Each point is conveniently fixed to its respective adapter by a suitable locking mechanism such as a transversely extending engaging pin passing through the external walls of the point and through an aligned cavity in a forwardly extending nose of the adapter. Generally, the adapter has a chosen profile matched by an interior cavity of the point. After a period of service (which in harsh conditions can be quite short e.g. a few hours), the point will become worn and need to be quickly and safely removed from the adaptor and replaced.

It has been found that frequently there is difficulty in removing the point due to it being jammed onto the adapter as a result of the ingress of fines and the effect of the considerable loads applied to the point along its tip during digging operations. Fines and other material become packed between a point and an adapter and various techniques have been necessary to remove points from adapters including, levering, thermal gouging and destructive processes. The cost of downtime is considerable as well as the demands on operators who are seeking to change points in remote worksite locations where safety considerations are very important. For example, if hammers are used in the process of disengaging components, there is a risk of injury including a risk from flying chips of metal and debris. Furthermore, such operations are labour intensive.

### SUMMARY OF THE INVENTION

Disclosed is a tool for disassembling an excavation tooth assembly comprising first and second tooth members, the tool comprising:
a body comprising a driven portion and first and second legs, the legs extending generally in a common plane and defining an assembly receiving cavity therebetween, each of the first and second legs comprising a wedge portion adjacent the assembly receiving cavity which tapers toward a distal end of the respective leg, in use the tool being adapted to locate over a join defined between the first and second tooth members such that the wedge portion of the first and second legs locates within the join and wherein in use a force applied to the driven portion is arranged to drive the wedge portion further into the join so as to cause separation of the first and second tooth members in a direction transverse to the movement of the first and second legs.

In one form the body further comprises a main portion from which the first and second legs depend.

In a particular form the legs are spaced apart and join with the main portion to form a U-shaped configuration.

In a particular form the legs extend from a lower surface of the main portion and the driven portion is mounted on an upper surface of the main portion opposite the lower surface.

In one form the driven portion comprises a coupling portion adapted to couple to a device for imparting the force. In addition, in a particular form, the driven portion further comprises a shank which extends from the upper surface of the main portion to the coupling portion.

In one form the coupling portion is spaced apart from the main portion such that, in use, movement of the coupling portion in a direction generally perpendicular to a longitudinal axis of the shank causes the wedge portion to impart a lateral force to at least one of the tooth members.

In a particular form the driven portion comprises an enlarged head located on the main portion.

In one form each of the legs further comprise an outer portion adjacent the wedge shaped portion which is of thicker width that the wedge shaped portion.

In one form the first tooth member is an adaptor and the second tooth member is a point of an excavation tooth assembly.

In a second aspect there is disclosed a method of disassembling an excavation tooth assembly comprising first and second tooth members which are coupled together such a gap is defined at a join between the two assembled members, the method comprising forcing a wedge into the gap in a direction transverse to a longitudinal axis of the excavation tooth assembly so as to cause separation of the first and second tooth members, the separation being generally in the direction of the longitudinal axis of the assembly.

In one form the force applied to the wedge is a percussive force. In a particular form the method comprises utilising a jack-hammer (or other suitable force imparting device) to apply the percussive force.

In one form a further gap is located on an opposite side of the join, the method further comprising forcing a second wedge into the further gap in unison with the forcing of the first wedge.

In another aspect there is disclosed an excavation tooth member adapted to be mounted on a body portion of a supporting tooth member, the excavation tooth member having an end structure which at least partially surrounds a cavity in which the body portion of the supporting tooth member fits;
the end structure having a raked portion defining an abutment surface arranged so that an inwardly tapering gap is defined between the abutment surface and a confronting portion of the supporting tooth member; whereby the members may be disassembled by application of a tool having a wedge shaped element which is arranged to be driven into the gap.

In another aspect there is disclosed an excavation tooth support member comprising a body portion adapted to mount a second tooth member, the body portion comprising a shoulder section having a raked portion defining an abutment surface arranged so that an inwardly tapering gap is defined between the abutment surface and a confronting end structure of the second tooth member when in an assembled state; whereby the members may be disassembled by application of a tool having wedge shaped element which is arranged to be driven into the gap.

In yet another aspect there is disclosed an excavation tooth system comprising first and second excavation tooth members, the first and second tooth members being assembled such that a body portion of the first tooth member is located substantially within a socket defined in a body of the second tooth member, the system further comprising a disassembly tool comprising a wedge portion which is arranged to locate in gap defined at a join between the first and second tooth members, in use the wedge portion of the tool being arranged to be driven into the gap so as to cause separation of the first and second tooth members in a direction transverse to the movement of the wedge portion.

In a particular form the second tooth member at a joining end comprises an end structure which at least partially surrounds the socket and the body portion of the first tooth member includes a shoulder section defined on opposite walls thereof which are closely spaced from the end structure whereby gaps are defined.

In one form, one or both of the first and second tooth members of the excavation tooth system is in accordance with one of the tooth members or tooth support members of the second and third aspects.

In one form the disassembly tool is the tool as described in accordance with the first aspect, whereby the legs of the tool locate in the respective gaps to affect the separation.

In a particular form the tool further comprises a force imparting device coupled to the tool which is arranged to impart the force.

In one form the force imparting device comprises a jackhammer arranged to impart a percussive force for separating the tooth members.

In accordance with a further aspect there is provided a mount for a disassembly tool for an excavation tooth assembly comprising first and second tooth members, the mount comprising:
a mounting portion arranged to detachably mount to one or both of the first and second tooth members; and
a reaction portion connected to or integrally formed with the mounting portion and arranged in use to be spaced from the first and second tooth members, the reaction portion being arranged to mount a force actuating device which, in use, is arranged to impart a force to the disassembly tool so as to cause separation of the first and second tooth members, wherein the reaction portion is arranged to accommodate the reaction loading induced by the force actuating device.

In one form the reaction loading experienced by the mount as it drives the disassembly tool is resisted by connection of the securing portion to the first and/or second tooth member.

In a particular form the mount further comprises a guide portion arranged to guide movement of the disassembly tool under the force imparted by the force actuating device. In one form, the guide portion retains the disassembly tool after the separation has been affected.

In one form the guide portion comprises a channel arranged to receivingly guide an arm coupled to the disassembly tool.

In one form the mounting portion comprises a pair of clamping legs each having a first end which couples to a body of the mount and a second end comprising a coupling portion which, in use, locates within a cavity provided on a body of the first and/or second tooth member. The cavities may, in ordinary use, be arranged to receive an engaging pin of a locking mechanism for maintaining the first and second tooth members in an assembled relationship.

In a particular form the force actuating device comprises a hydraulic or pneumatic ram.

In one form the reaction portion comprises a mounting cradle arranged to couple to the disassembly tool and which mounts a body of the ram.

In one form the reaction portion further comprises an abutment structure which is spaced apart from and located in substantially the same plane as the mounting cradle, such that in use an arm of the hydraulic ram bears against the abutment structure to thereby cause the disassembly tool to be driven toward the tooth assembly.

In one form the mount further comprises a lug arranged to receive a hook of a lifting apparatus. For example, the lug may be shaped so as to receive a hook of a hoist or crane which in turn may advantageously manoeuvre into place and hold the apparatus during the disassembly operation. Once disassembled, the crane can then readily remove the worn tooth member which is still secured to the mount.

In a particular form the mount further comprises an adjustment mechanism arranged to adjust a retaining angle of the disassembly tool with respect to the tooth assembly for suitably aligning the tool (e.g. as a result of side wall variation due to wear). In another embodiment, the adjustment mechanism may alternatively or additionally apply a separating force between the mount and tooth member(s) to which it is coupled for increasing the stability of the apparatus. The adjustment mechanism may be in the form of a bolt assembly. A bolt retained by the bolt assembly may be screwed downwardly such that an end bears down on the tooth member.

In one form the adjustment mechanism comprises an internally threaded housing retaining a bolt, an end of which is in contact with a surface of the first and/or second tooth member such that turning the bolt causes the retaining angle to change.

In a particular form the mounting portion comprises a lower frame defining a base and upwardly extending arms which project partly into a gap between the first and second tooth members in a bottom region and the reaction portion comprising an upper frame adapted to be connected to the lower frame and providing an abutment structure for receiving one end of a hydraulic ram, the other of which is adapted to be applied to the disassembly tool.

In one form at least one of the mounting portion and reaction portion comprises guide arms extending around the frame to guide the tool slidingly along the frame as a wedge portion of the tool is inserted into the gap.

In yet another aspect there is disclosed a disassembly apparatus comprising a mount as previously disclosed coupled to a tool as disclosed in accordance with the first aspect.

In accordance with another aspect there is provided a disassembly tool for an excavation tooth assembly comprising first and second tooth members, the disassembly tool comprising:
a body comprising a wedge portion which is arranged to locate in a gap defined at a join between the first and second tooth members; and
a shank extending from the body to a coupling portion adapted to couple to a device arranged to impart a drive force to the wedge portion, such that as the drive force is imparted the wedge portion is driven into the gap to separate the first tooth member from the second tooth member.

In a particular form the tooth assembly of the disassembly tool, apparatus, mount and/or method in accordance with any one of the previously disclosed aspects comprises a combination of the following excavation tooth members: a digging point, adaptor, mid-adaptor, end adaptor, plate lip adaptor and cast lip integral nose.

In accordance with a still further aspect there is provided a tool for removing a ground engaging point from an adapter to which it is secured, the point at its rear end having a collar extending substantially in a plane normal to be axis of the point and surrounding a cavity into which a nose of the adaptor fits, the adapter having a body structure extending therearound and closely spaced from the collar of the point whereby gaps are defined;
the tool comprises a body portion and a first and second depending legs shaped and configured to be inserted into the gaps on opposite sides of the point, the body portion of the tool being adapted to receive force to drive the legs into the gaps, each of the legs having a tapering structure adapted to engage on respective sides of the collar and the corresponding body portion of the adapter as the legs are driven into the gaps;
whereby in a wedging action the tool can be driven to force apart the point and the nose.

In accordance with another aspect the present invention provides a mining bucket mid-adaptor for mounting on the nose of an end adapter integrally formed into a lip of a mining bucket, the mid-adaptor having at its rear end a collar which surrounds a cavity into which the nose fits;
the collar having at least a portion thereof defined by an abutment surface extending at a shallow angle to the plane normal to the axis of the mid-adaptor so that the adjacent gap between the surface and the confronting portion of the end adapter is wider near one edge of the mid-adaptor and narrower in a central region;
whereby the parts may be disengaged by the application of a tool having wedge shaped elements arranged to be driven into the adjacent gaps.

### BRIEF DESCRIPTION OF THE DRAWINGS

Embodiments will now be given by way of example with reference to the accompanying drawings in which:

FIG. 1 is a side elevation of a first embodiment of a digging point for mounting on an adapter;

FIG. 2 is a perspective view from the rear showing the point of FIG. 1;

FIG. 3 is a perspective view of an adapter having a nose in which the point is adapted to be mounted;

FIG. 4 is a side view of the adapter on which the point is assembled and with a disengagement tool offered up for use in disengaging the parts;

FIG. 5 is a perspective view of the tool for disengaging the parts;

FIG. 6 is a front elevation of the tool of FIG. 5;

FIG. 7 is a side elevation of the tool of FIG. 5;

FIG. 8 is a side view on a large scale as part of a second embodiment of digging point with an altered profile in the collar region at the rear open end of the point;

FIG. 9 is a rear perspective view of the digging point of FIG. 8;

FIG. 10 is a plan view of the rear portion of the digging point of FIG. 8;

FIG. 11 is a side elevation view of an adaptor in accordance with an embodiment;

FIG. 12 is a front elevation of the adaptor of FIG. 11;

FIG. 13 is a sectional plan view of the digging point of FIG. 8 mounted on an adapter and taken along the line XI-XI of FIG. 14;

FIG. 14 is a sectional side elevation of the digging point and adapter of FIG. 13 and taken along the line XII-XII of FIG. 13;

FIG. 15 is a perspective view of a second embodiment of tool for use particularly with the point of FIG. 8;

FIG. 16 is a perspective view from the rear of the tool of FIG. 15;

FIG. 17 is a perspective view of the tool of FIG. 15 with its mounting frame;

FIG. 18 is a front elevation of the tool of FIG. 17;

FIG. 19 is a side elevation of the tool of FIG. 18;

FIG. 20 is a sectional side elevation taking along the line A-A of FIG. 18;

FIG. 21 is a perspective view of the digging tooth and adapter with the tool offered up for disengaging the parts and corresponding to FIG. 14;

FIG. 22 is a view corresponding to FIG. 21 from the rear view;

FIG. 23 is a perspective view of a digging tooth assembly, mount and tool offered up for disengaging the parts in accordance with another embodiment;

FIG. 24 is a view corresponding to FIG. 23 from the rear;

FIG. 25 is a view corresponding to FIG. 23 from the side;

FIG. 26 is a view corresponding to FIG. 23 from the front;

FIG. 27 is a rear perspective view of the mount and tool only of FIG. 23;

FIG. 28 is a side elevation view of FIG. 27;

FIG. 29 is an end elevation of FIG. 27;

FIG. 30 is a front elevation of FIG. 27;

FIG. 31 is a rear perspective view of the assembly of FIG. 23 whereby the wedge of the tool is facing towards the point.

FIGS. 32 to 35 show various engineering views of a tool according to a further embodiment;

FIGS. 36 is an isometric view of the tool and mount, in accordance with an embodiment;

FIG. 37 is an isometric view of the tool and mount of FIG. 36 secured to a point and adaptor assembly;

FIG. 38 is a side view of the FIG. 27 tool and mount offered up for use with a cast lip adaptor assembly;

FIG. 39 is a side view of FIG. 38 with the point removed; and

FIG. 40 is an exploded view of a bucket lip showing the mid adaptor and point, in accordance with an embodiment.

FIGS. 41 through 43 are engineering views of a mount and tool, in accordance with yet a further embodiment.

### DETAILED DESCRIPTION OF THE INVENTION

The following description relates to disassembly tools, mounts and corresponding methods of use, for disassembling an excavation tooth assembly comprising first and second tooth members. While specific embodiments are hereafter described in the context of an excavation tooth assembly comprising a first tooth member in the form of a digging point and a second tooth member in the form of an adaptor, it will be understood that embodiments are equally applicable for disassembling other combinations of tooth members selected from the non-exhaustive group comprising points, adaptors, mid-adaptors, end adaptors, plate lip adaptors, cast lip integral noses and the like. Such excavation teeth members are commonly found on dredger cutting head assemblies, drag line bucket assemblies, excavation buckets, electric rope shovels and the like.

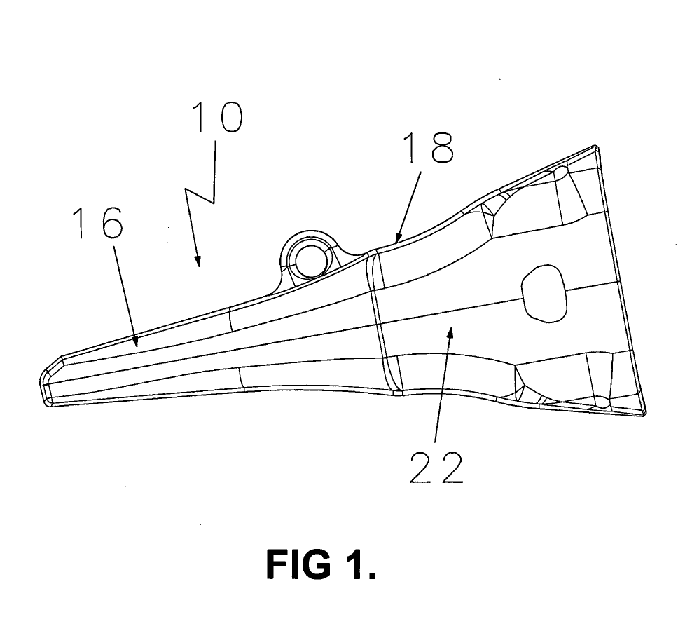

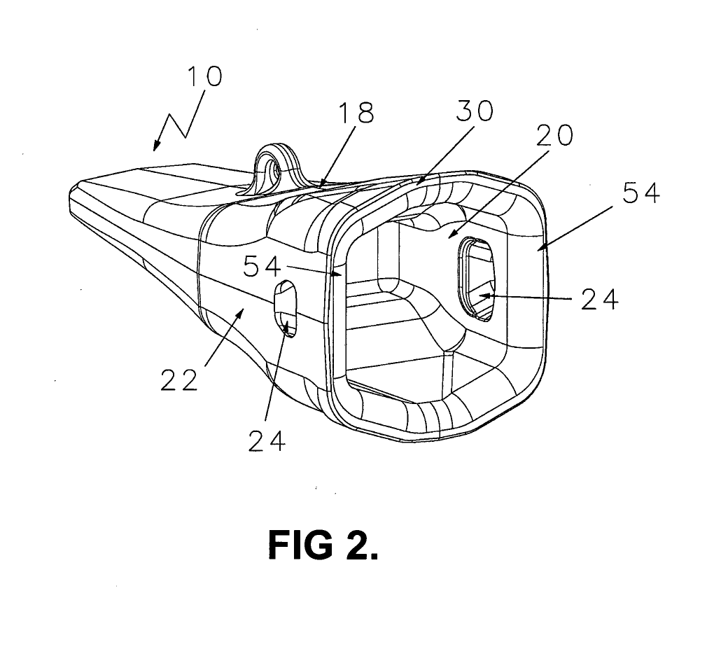

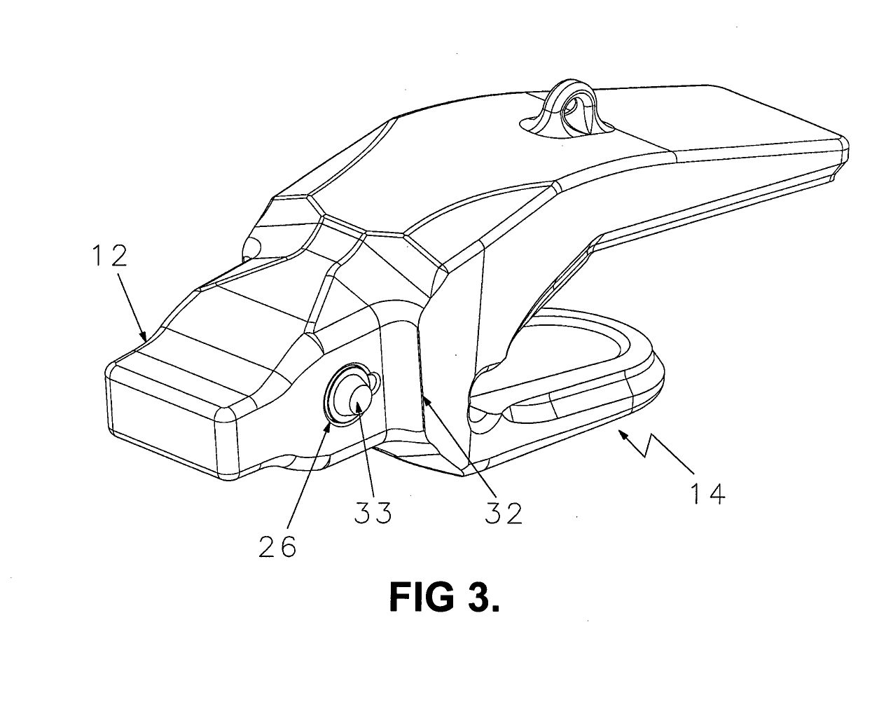

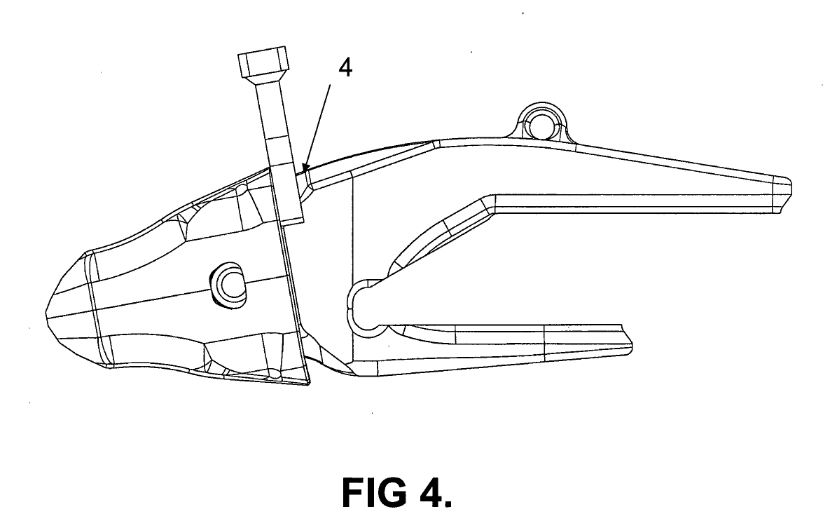

With reference to FIGS. 1 and 2 there is shown a tooth member in the form of a digging point 10 which is arranged to be mounted on the nose 12 of an adapter 14 (shown in isolation in FIG. 3), such that a gap 4 is created at a join between the digging point 10 and adaptor 14. Such an assembled configuration is depicted in FIG. 4.

In more detail, the point 10 has an elongate digging tip 16 extending from a main body 18 within which a complex shape cavity is provided, the cavity having a profile to match intimately the shape of the nose 12 of the adapter. The body 18 has side walls 22 having aligned cavities 24 which align with a transverse cavity 26 extending through the adapter. The cavities 24 are of a generally oval shape and taper in dimension from the inside wall to the outside face of side wall 22. The rear open end of the point terminates in a peripheral end structure (in the illustrated embodiment being in the form of a collar 30) which confronts but is spaced from a confronting shoulder 32 from the body of the adapter. As shown in FIG. 1, the collar 30 is substantially in a plane transverse to the longitudinal axis of the point.

In the illustrated embodiment, the adapter 14 mounts within its transverse cavity an axially expandable locking element 33. Upon engagement of the point on the nose of the adapter, a locking tool is used to axially expand the lock so it extends into the cavities 24 in firm engagement to retain the point on the adapter.

After a period of service, which can be short in harsh conditions, the digging point 10 may become heavily eroded and in need of replacement. Typically the adapter will be fixed to the lip of a carrying bucket of large dimensions and the point projects from this lower lip for digging purposes. FIG. 4 depicts the assembly with a typical worn point ready to be removed.

Embodiments provide a tool which, in its most basic form, comprises a wedge shaped element which can be driven into the gap 4 in a direction transverse to a longitudinal axis of the excavation tooth assembly, so as to cause separation of the point and adaptor.

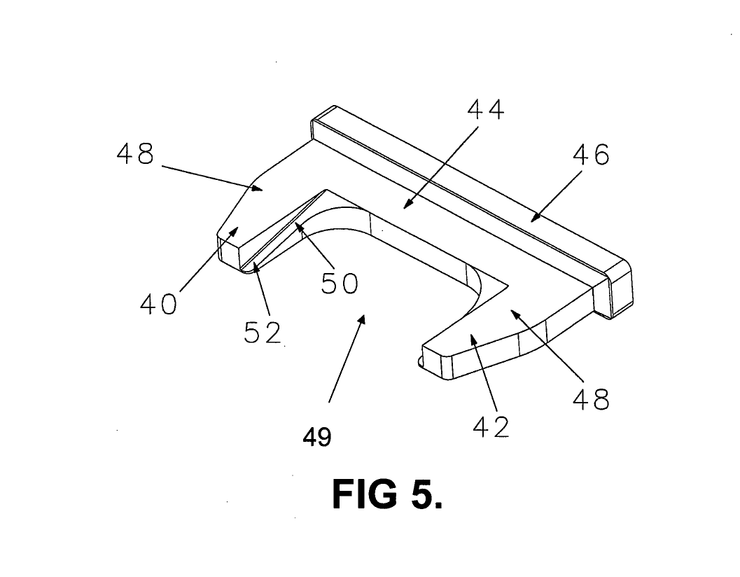

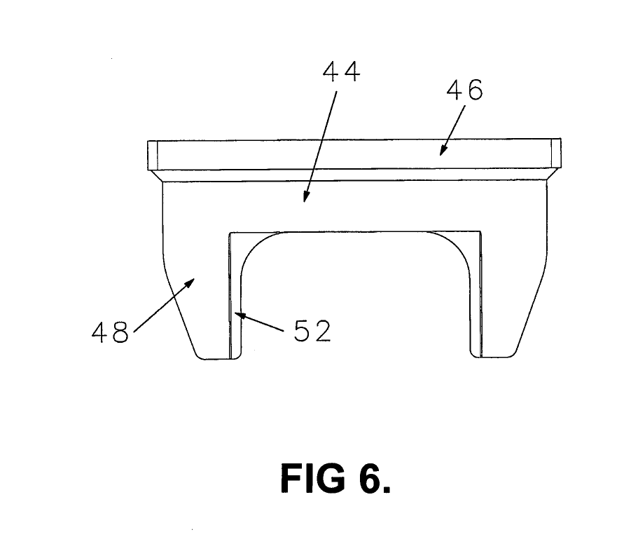

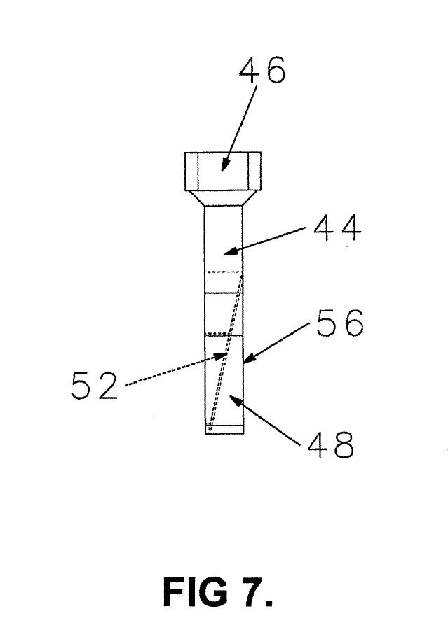

FIG. 4 shows offered up for use one such disassembly tool being a first embodiment of the invention. The tool is shown in more detail in FIGS. 5 to 7 and comprises a main body 44 having the form of a transverse cross-bar 44. First and second legs 40, 42 depend from the cross-bar 44. A driven portion in the form of an abutment head 46 is integrally formed with the transverse cross-bar 44 for receiving hammer blows or optionally, force otherwise applied for example through a hydraulic ram, pneumatic jackhammer, etc. Each of the legs 40, 42 in the illustrated embodiment has a robust body 48 chamfered on the exterior edge and an integrally formed flange 50 which has a wedge shaped portion in the form of a ramp surface 52. The legs 40, 42 each extend from the cross-bar 44 generally in a common plane to define an assembly receiving cavity 49. In the illustrated embodiment, the legs 40, 42 are spaced apart and join with the transverse cross-bar 44 to form a U-shaped configuration.

In use, and as shown in FIG. 4, the ramp surfaces 52 of the legs 40, 42 engage with side portions 54 of the collar 30 of the point and rear surfaces 56 of the legs engage with the confronting shoulder side portions of the adapter 14. The tool is adapted to be hammered vertically downwardly so as to cause separation of the point 10 from the adapter 14 in a direction transverse to the movement of the first and second legs. It has been found that after a period of service, fines compact in the zone between the point and the adapter which has been the subject of a high level of axial force during the digging operations and frequently the point becomes jambed on the adapter. Thus, this embodiment provides a tool which in an inexpensive but simple matter permits rapid and enhanced separation of the point and the nose in a manner which is safe and easily effected with a simple tool by a single operator.

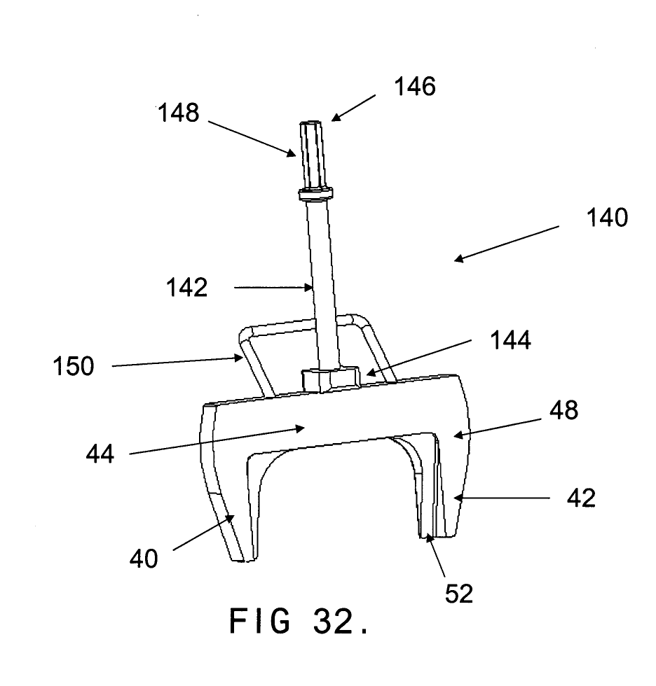

An alternative form of the disassembly tool is shown in FIGS. 32 to 35. According to this embodiment, the disassembly tool 140 further comprises a coupling portion which allows the tool 140 to be coupled to a force imparting device for imparting the necessary force to drive the wedge portions 52 of the depending legs 40, 42 into the gap 4, for separating the assembled tooth members. In the illustrated embodiment, the drive force applied to the disassembly tool 142 is a percussive force and the device utilised to impart the percussive force is a pneumatic jack hammer 143 (although it will be understood by persons skilled in the art that other devices may equally be suited for such an application, including hammer drills, non-pneumatic jack hammers and the like).

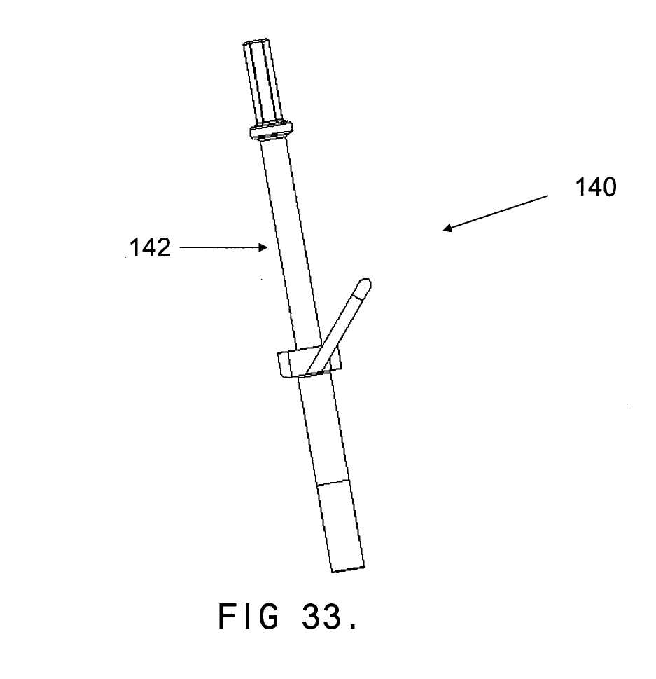

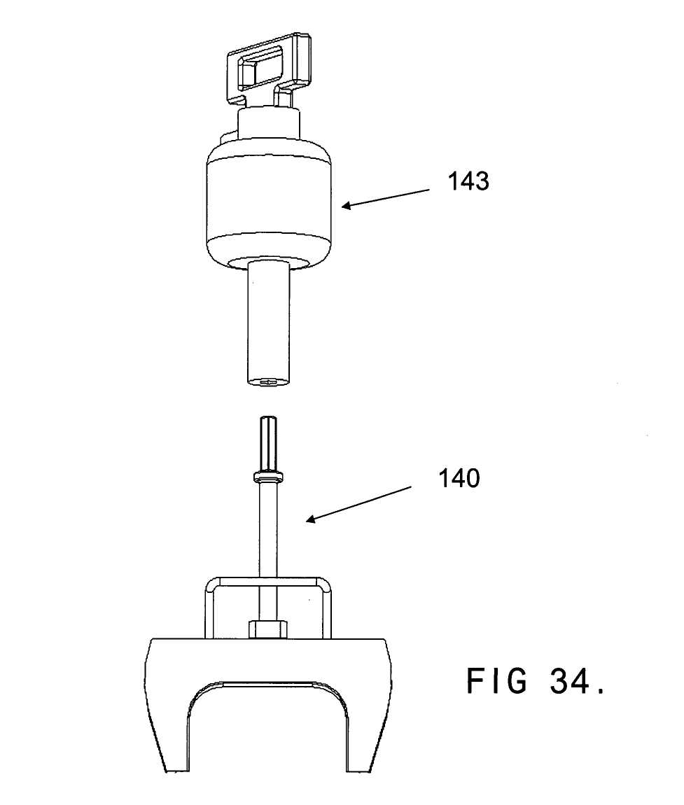

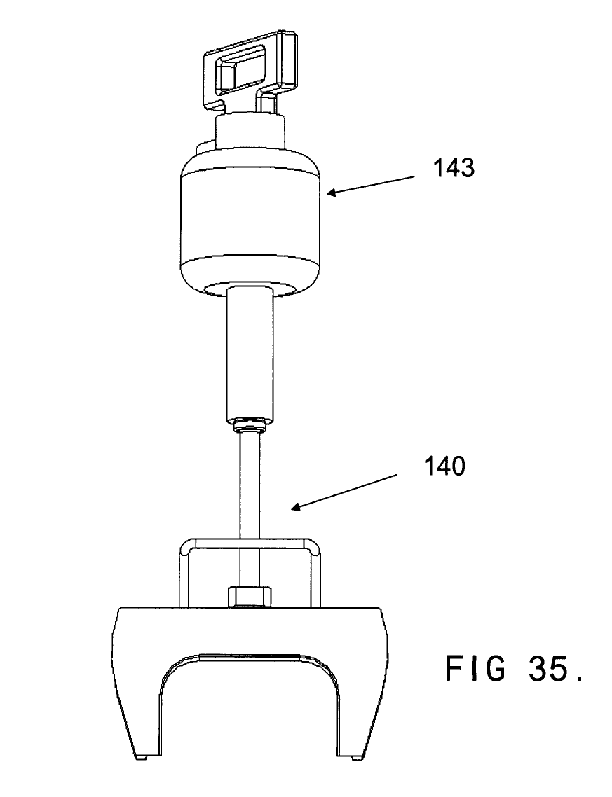

In more detail, and with particular reference to FIGS. 32 and 33, a shank 142 extends from a top plate 144 which is provided on an upper surface of the transverse cross bar 44. A coupling portion 148 is provided at a distal end 146 of the shank 142 and has a profiled head (in the illustrated embodiment the head has a hex-bolt profile for allowing the device to suitably grip the shank, although it will be understood that other profiles may be equally applicable), which is adapted to be received in a correspondingly shaped socket provided on the pneumatic jack hammer 143. This coupled arrangement is best shown in FIGS. 34 and 35. A handle 150 is provided for manoeuvring the tool 140.

In use, the tool 140 is positioned between the point and adaptor in much the same manner as described for the FIG. 4 embodiment. Once suitably positioned, the pneumatic jack is turned on (e.g. by an operator standing on one side of the assembly) which in turn applies a repeated impact/percussive force for driving the wedge downwardly into the gap, causing the adaptor and point to separate in a direction generally transverse to the movement of the tool. In the illustrated embodiment, the coupling portion 148 is spaced apart from the top plate 144 such that movement of the coupling portion in a direction perpendicular to a longitudinal axis of the shaft during operation of the tool 140 causes the wedge portion to impart a lateral force to at least one of the first and second tooth members for assisting separation of the excavation tooth assembly (i.e. once the wedge has sufficiently separated the assembled parts for allowing the lateral movement).

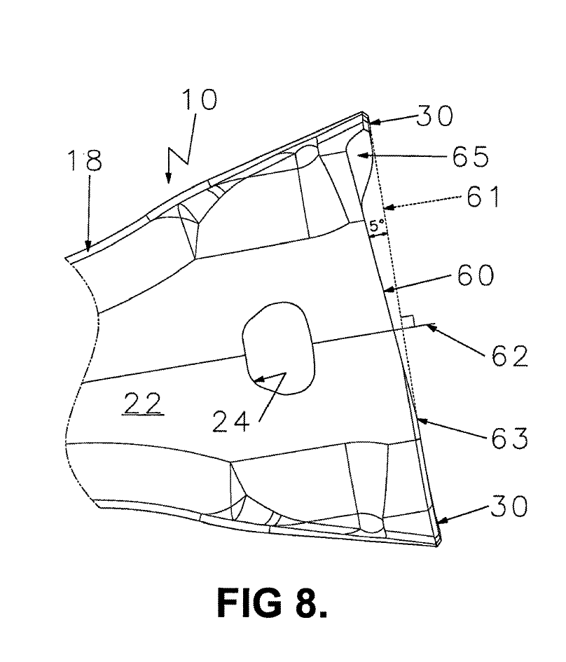

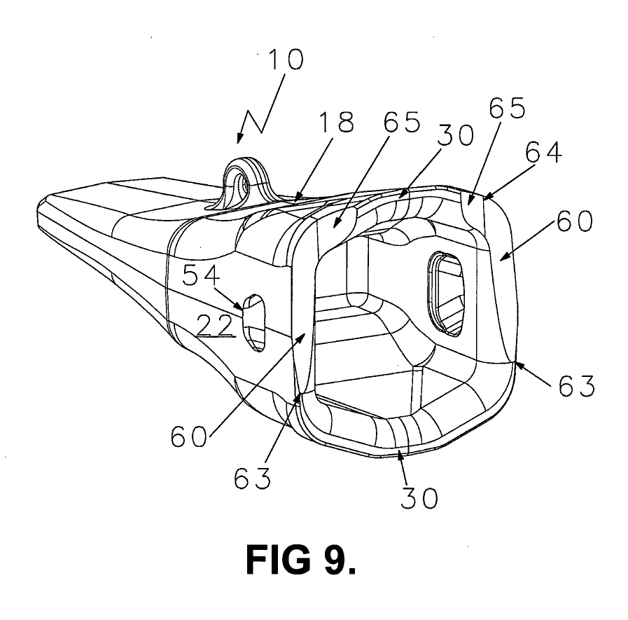

In a particular arrangement, the point (or other suitable tooth member) may have a rear profile which cooperates with the disassembly tool for facilitating separation. FIGS. 8 and 9 show one such arrangement. According to the illustrated embodiment, the collar 30, or equivalent end structure, comprises a raked portion defining an abutment surface arranged so that an inwardly tapering gap is defined between the abutment surface and a confronting portion of the adaptor. In more detail, the collar 30 is raked so as to form angled flat side faces 60 extending at about 5° from the general plane 61 defined as normal to axis 62 of the point (as best shown in FIG. 8). The flat faces 60 merge with the original collar profile at merge location 63 and extend to the upper edge 64 of the side wall where a concave shoulder 65 continues to merge the central upper portion of the collar 30.

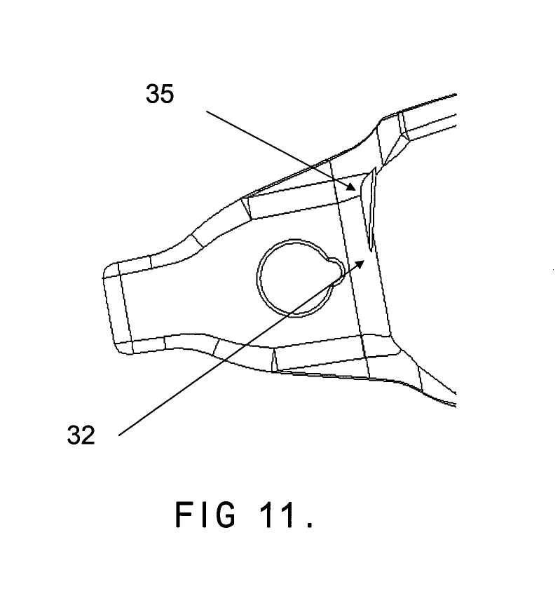

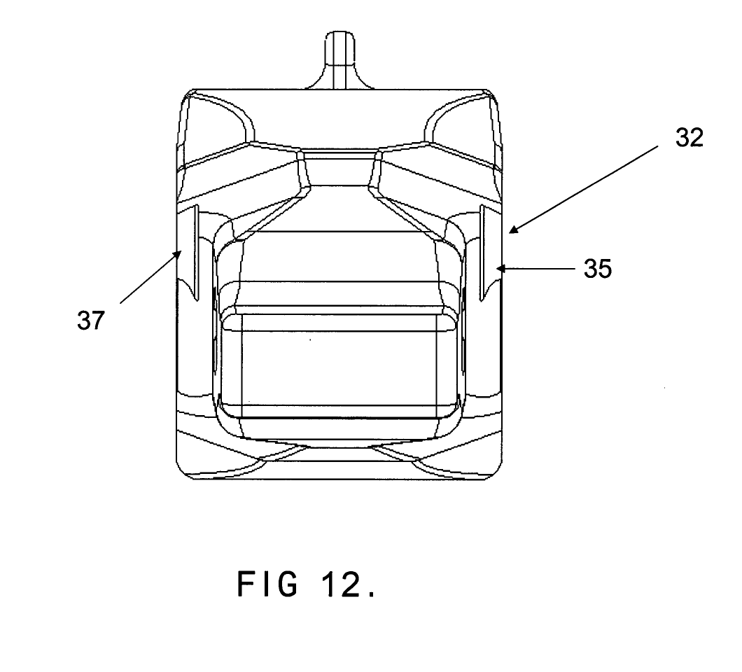

Equally, the adaptor (or other tooth member support) on which the point mounts may comprise a raked portion for co-operating with the disassembly tool. One such example embodiment is shown in FIGS. 11 and 12. According to such an embodiment a raked portion 35 is provided on the adaptor shoulders 32 thereby defining an abutment surface 37, arranged so that an inwardly tapering gap is defined between the abutment surface 37 and the collar 30 when in an assembled state.

In one form, the raked portion may be on only one of the inter-fitting tooth members. In another form, the raked portion may be on both tooth members.

In an embodiment the tool may be coupled to a mount for facilitating disassembly of the tooth members. In an embodiment the mount comprises a mounting portion arranged to detachably mount to one or both of the adaptor and point. The mount further comprises a reaction portion which is connected to, or integrally formed with, the mounting portion and arranged to be spaced apart from the point and adaptor. A force actuating device couples to the mount to impart a force to the tool so as to cause the separation. Advantageously, the reaction portion is arranged to accommodate the reaction loading induced by the force actuating device.

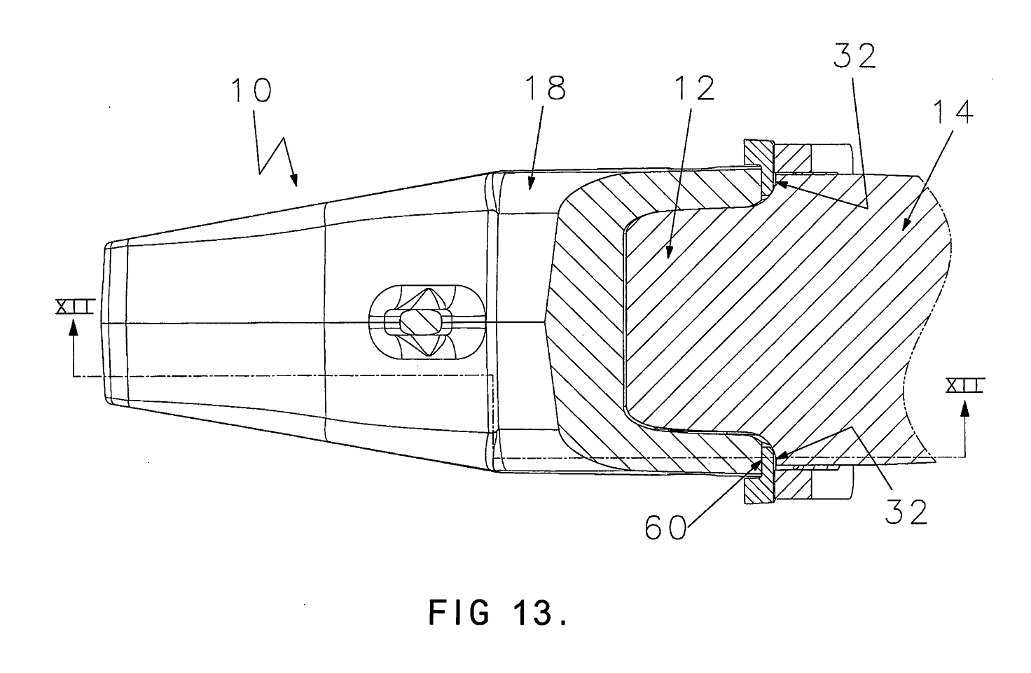

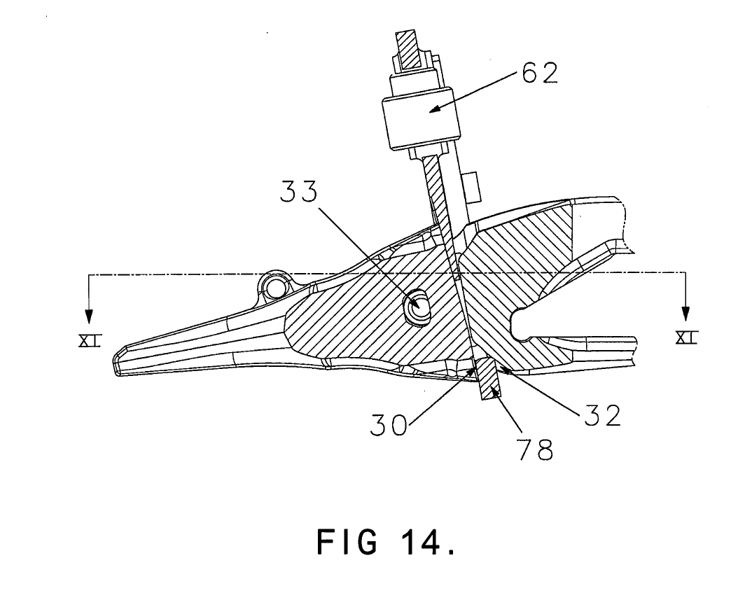

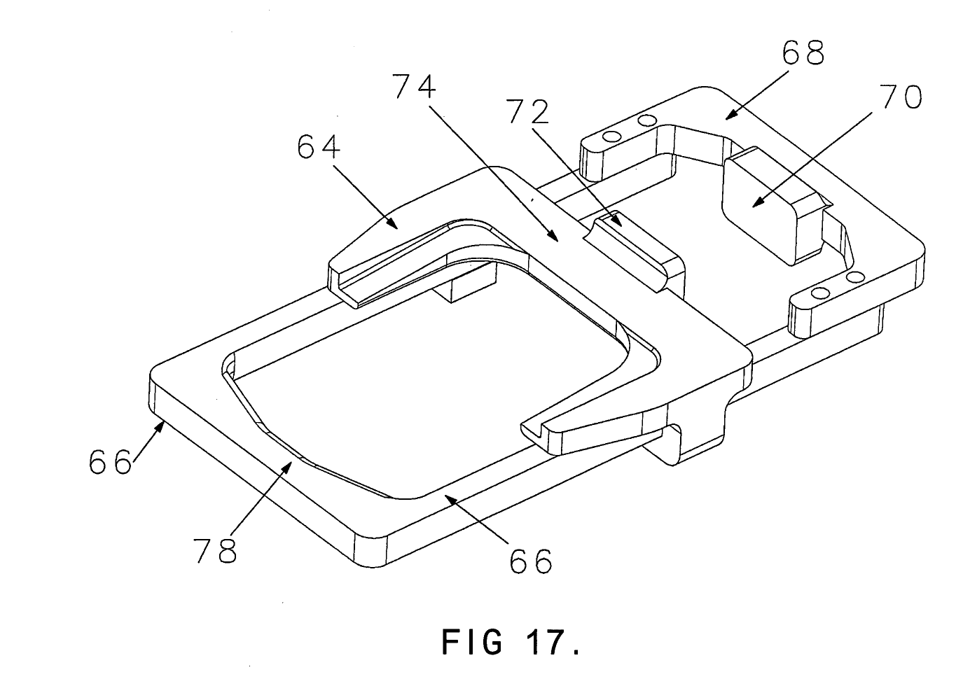

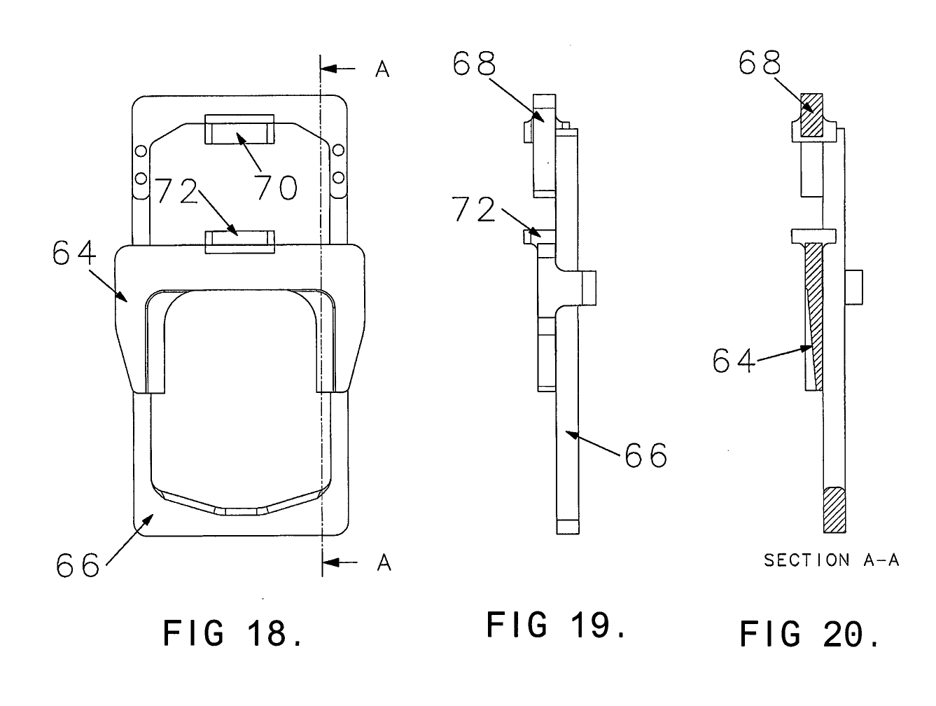

One such mount is shown in FIGS. 13 to 22. In this embodiment, a complimentary disassembly tool is provided to be forced transversely to the axis of the point into the gap between the flat faces 60 and the confronting shoulder of the adapter. FIGS. 13 and 14 show the tool initially offered up and ready for the application of force from a hydraulic ram 62.

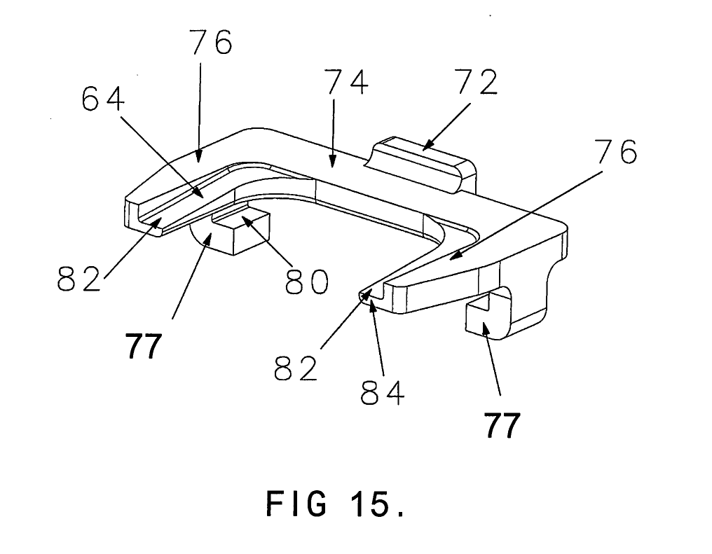

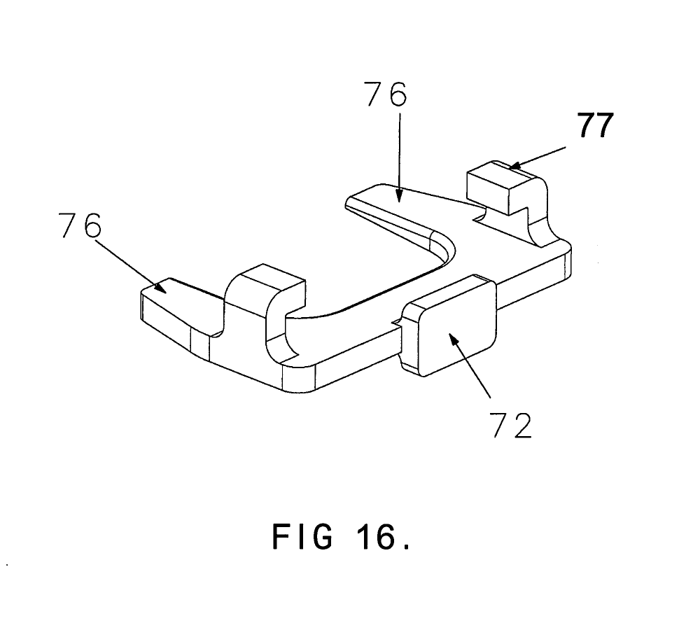

The assembled tool and mount is shown in FIGS. 14 and 17 to 20 and comprises a generally U-shaped engagement tool 64 shown in more detail in FIGS. 15 and 16, a U-shaped lower frame 66 and a top frame 68 which carries an abutment pad 70 which compliments another abutment pad 72 carried on a cross-bar 74 of the engagement tool. As shown in FIG. 14 a force actuating device in the form of a hydraulic ram 62 is adapted to be located between the pads 70 and 72 and application of hydraulic force forces the engagement tool 64 downwardly to slide over the lower frame 66 and to slide into the wedge shaped gap between the side faces 60 of the point and the confronting surface of the shoulder of the adapter.

Referring now to FIGS. 15 and 16, the tool 64 has side legs 76 extending from the cross-bar 74 and carrying respective guide arms 77 which extend from each leg 76 to provide an engagement surface 80 for sliding over the lower frame. Each leg has an inwardly directed tapered flange 82 terminating in a thin tip 84.

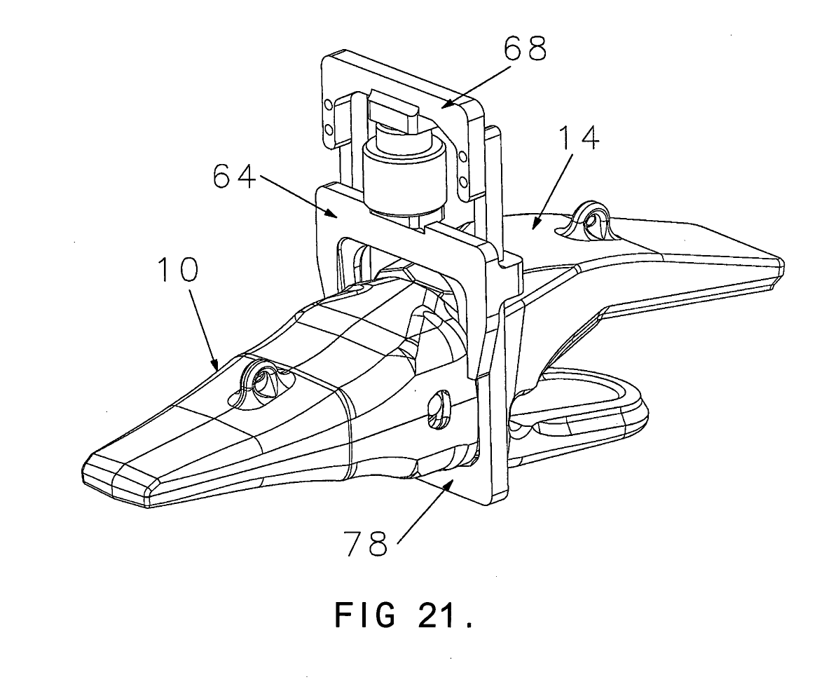

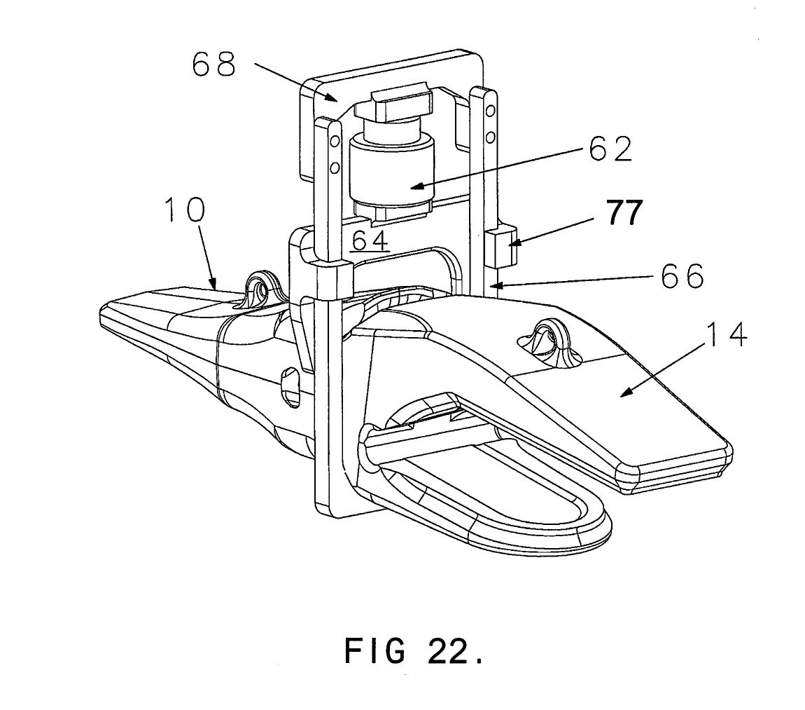

Installation on an assembled point and adapter is shown in FIGS. 21 and 22. Installation is achieved by firstly sliding the lower U-shaped frame 66 up underneath the ground engaging tool so that the bottom bar 78 engages between the bottom portion of the collar 30 and a confronting shoulder of the nose of the adapter. The engagement tool 64 has its arms 77 engaged around the upper part of the legs of the U-shaped frame 66 and it is slid down so that wedge shaped flanges 82 engage against the flat side faces 60 of the point. The upper frame 68 is then secured by nuts and bolts to the top of the lower frame. The hydraulic ram 62 is then inserted between the abutment blocks 70 and 72 and actuated to expand the ram thereby taking up the clearance with continued application of hydraulic pressure then forcing the engagement tool 64 between the point and the adapter to separate the parts. This embodiment thus offers a speedy, very safe'and single operator action reliably to remove the point from the adapter.

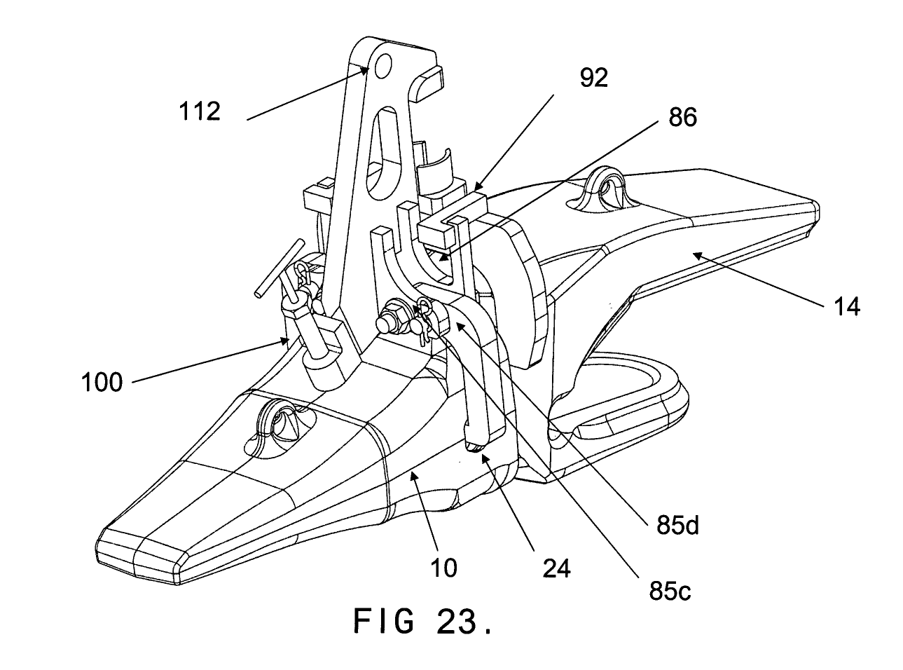

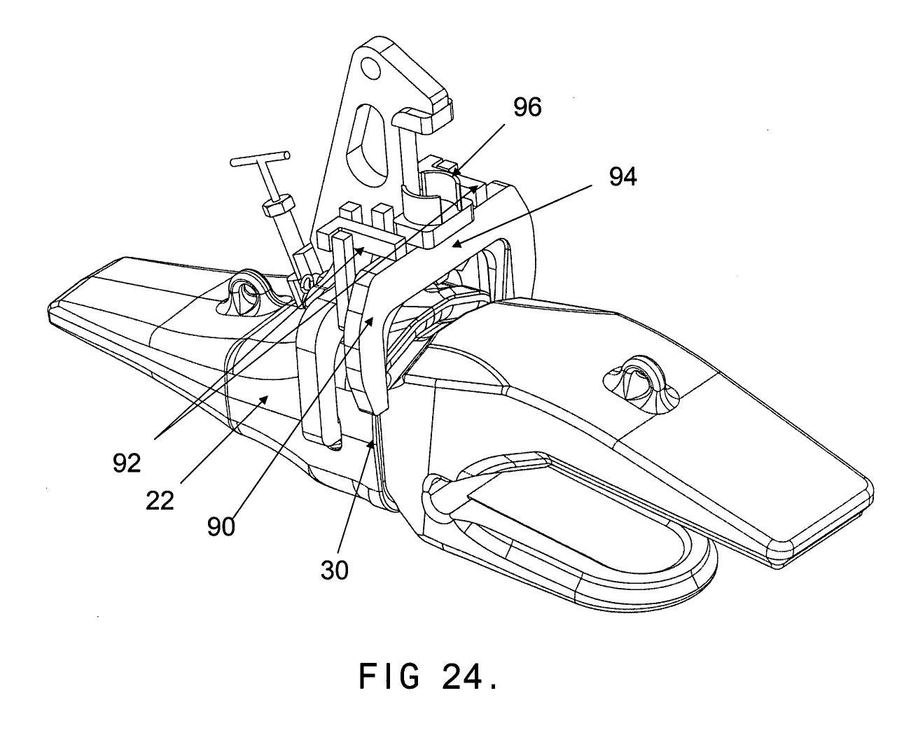

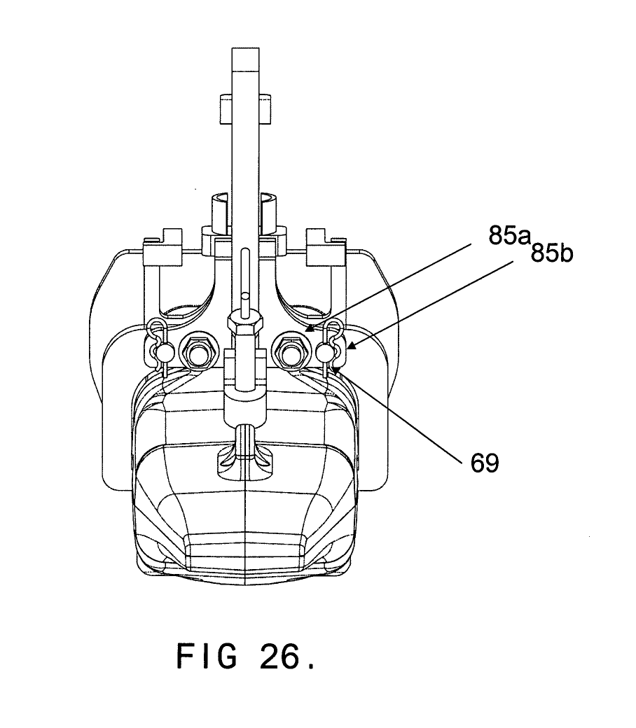

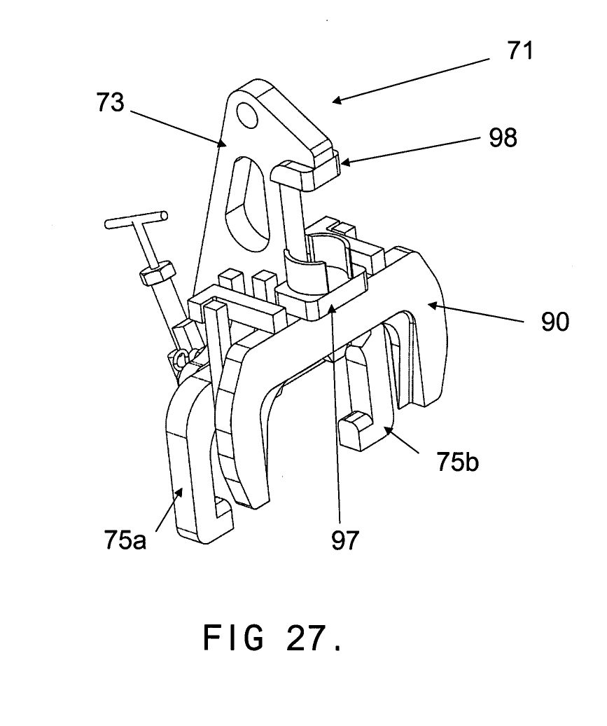

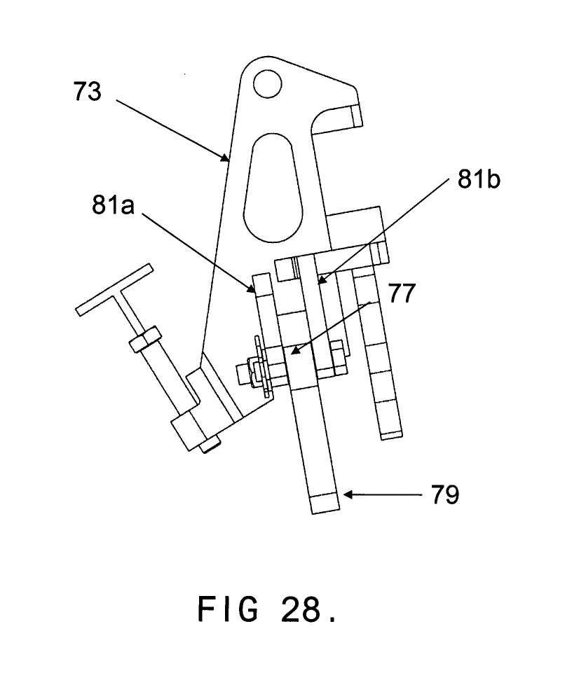

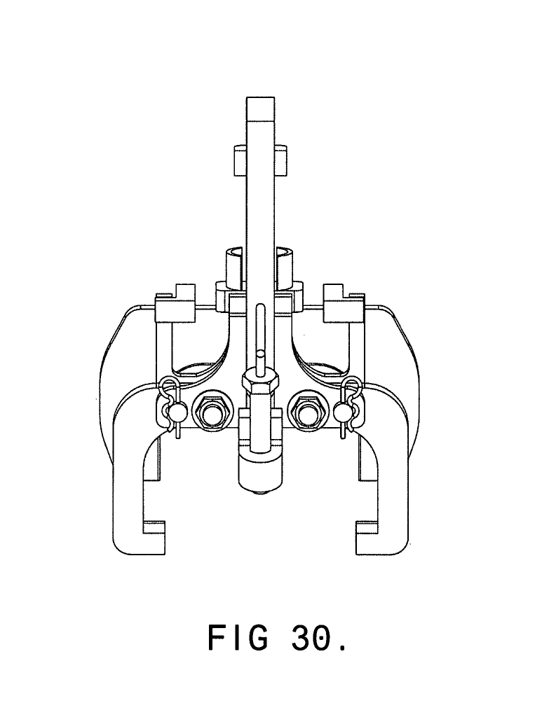

A further embodiment of a mount which employs a hydraulic ram for affecting separation is shown in FIGS. 23 through 30 (again like reference numerals are used to indicate like parts, as hereinbefore described). In this further embodiment, the mount 71 couples to a slightly modified disassembly tool to that previously described, for affecting the separation operation. As shown specifically in FIGS. 27 to 30, the mount 71 comprises a body 73 comprising a mounting portion 75 arranged to engage a body of the point 10 for securing the apparatus thereto. In the illustrated embodiment, the mounting portion 75 comprises a pair of clamping legs 75a, 75b each having a first end 77 which couples to the body 73 (as described in more detail below) and a second end 79 which securely locates within the opposing cavities 24 defined in the side walls 22 of the point 10. This is best illustrated in FIGS. 23 to 26.

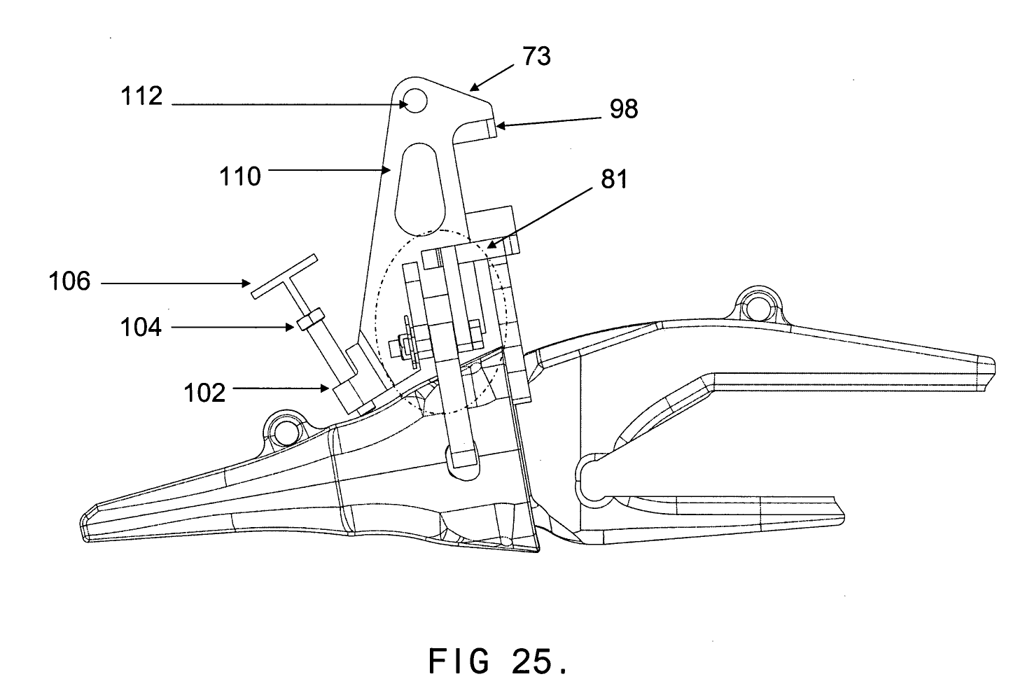

Each of the clamping legs 75a, 75b is coupled to the body 73 by way of a brace assembly 81. With particular reference to FIG. 25, each brace assembly 81 comprises a pair of arms 81a, 81b which extend from the body 73. The arms 81 further comprise a pair of aligned cavities 85a, 85b which align with cavities 85c, 85d respectively, provided in the first end 77 of the corresponding leg. In use, aligned cavities 85a, 85a receive a bolt or pin which allows the corresponding leg to pivot. Once suitably positioned (i.e. legs have been located in the point cavities 24), a pin is placed through aligned cavities 85b, 85d to thereby fixedly secure the mount 71 to the point 10. Such a configuration not only allows the mount to be securely attached to the point 10 during separation from the assembly, but also allows the point 10 to be easily discarded, as will be described in more detail in subsequent paragraphs. In this regard it will be noted that the clamp leg ends 79 may not extend any further than the inner walls of the point such that when removing the point they do catch on the lobe locatable in the side walls. To minimise installation/removal time, an R-clip 69 may be used to install/remove the bolt which passes through aligned cavities 85b, 85d.

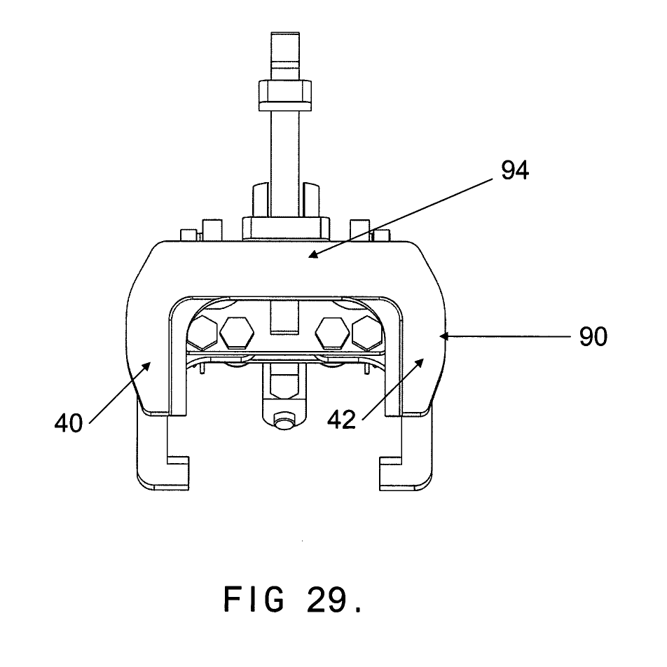

A guide channel 86 is defined in the rearmost arm 81b of each brace assembly 81 for receiving a respective arm 92 of a disassembly tool 90 used to separate the point from the assembly. As is evident from FIGS. 27 and 29, the tool 90 is in many ways identical to the tool shown in FIGS. 5 & 6 of the first embodiment. Like the tool of the first embodiment, the tool 90 comprises first and second depending legs 40, 42 shaped and configured to be inserted into the gaps on opposite sides of the point 10, as previously described. The most noticeable differentiation, however, is the pair of arms 92 (as mentioned above) which extend from the transverse cross-bar 94. Specifically, the arms 92 in combination with the guide channel 86 help to direct the tool 90 as it is forced downwardly for effecting the point separation. The configuration also advantageously operates to retain the tool 90 once the point has been separated from the adaptor 14. Another differentiation between the tool of the first embodiment and the tool 90 shown in FIGS. 23 through 30 is the mounting cradle 96 which serves to retain the hydraulic ram (not shown). The mounting cradle 96 is located on a driven portion 96 of the tool, which in the illustrated embodiment is located mid-way along the transverse cross-bar 94. An abutment structure in the form of a ram pad 98 extends from the body 73 and is located in substantially the same plane as the tool 90. In order to affect the driving force, an arm of the hydraulic ram bears up against the ram pad 98 thereby driving the separating wedge 90 into the gap defined between the point collar 30 and confronting shoulder of the nose of the adaptor 14 to separate the parts.

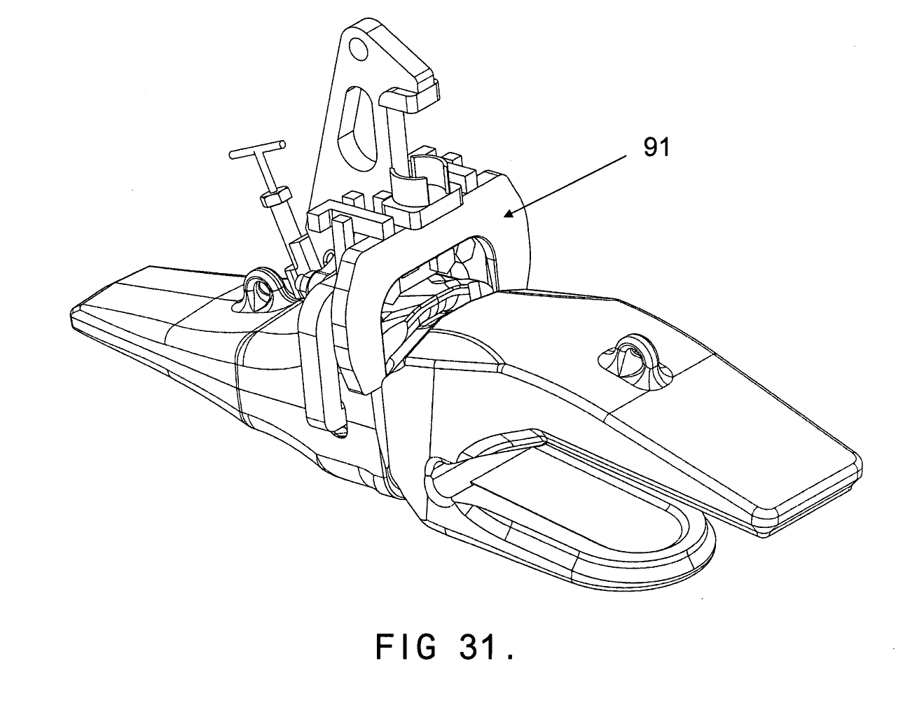

In an alternative embodiment, the tool employed by the mount is orientated in the opposite direction such that the ramp defined on each of the depending legs faces towards the point 10 instead of the adaptor (see FIG. 31). This is particularly advantageous where the modified point, such as the point previously described with reference to FIG. 8, is utilised. Indeed according to such an embodiment, the tool 91 may employ the same widened ramp structure as for the tool 64 of the afore-described second embodiment. In other words, the orientation and actual form of the tool implemented by the mount 71 may be changed depending on the type of assembled point/adaptor and separating characteristics required.

Referring back to the embodiment shown in FIGS. 23 through 30, it is not uncommon for the point 10 to be severely worn such that the original walls of the point no longer have the same shape as when the point was initially installed. To allow suitable alignment of the mount 71 due to such wear, an adjustment mechanism 100 is provided. According to the illustrated embodiment, the adjustment mechanism 100 is in the form of a bolt assembly comprising a bolt housing 102 which receives a bolt 104. The bolt can be screwed in or out of the bolt assembly to adjust the angle of the mount 71 with respect to the point 10. More specifically, as the bolt 104 is screwed in one direction an end thereof contacts with an upper surface of the point 10 in turn causing the mount (and thus the tool) to lean to the right. As the bolt 104 is turned in the other direction, the mount 71 tends to lean to the left. An end of the bolt 104 may be provided with a handle 106 for ease of use. A lug 110 located at an upper end of the body 73 is shaped so as to receive a hook of a hoist or crane. The hoist/crane may advantageously manoeuvre into place and hold the mount 71 during the separation operation. Once separated, the crane/hoist can then readily remove the used point 10 which is still secured to the mount 71 by the clamping legs 75.

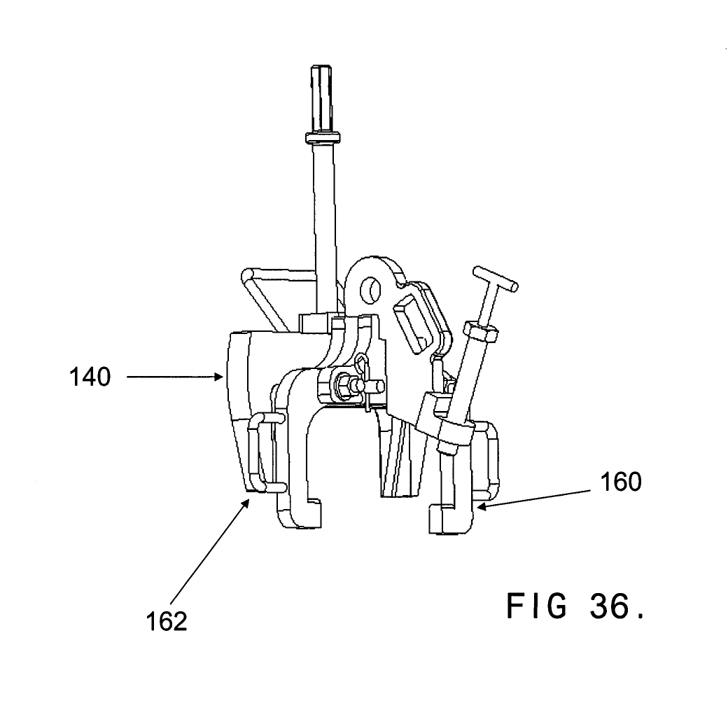

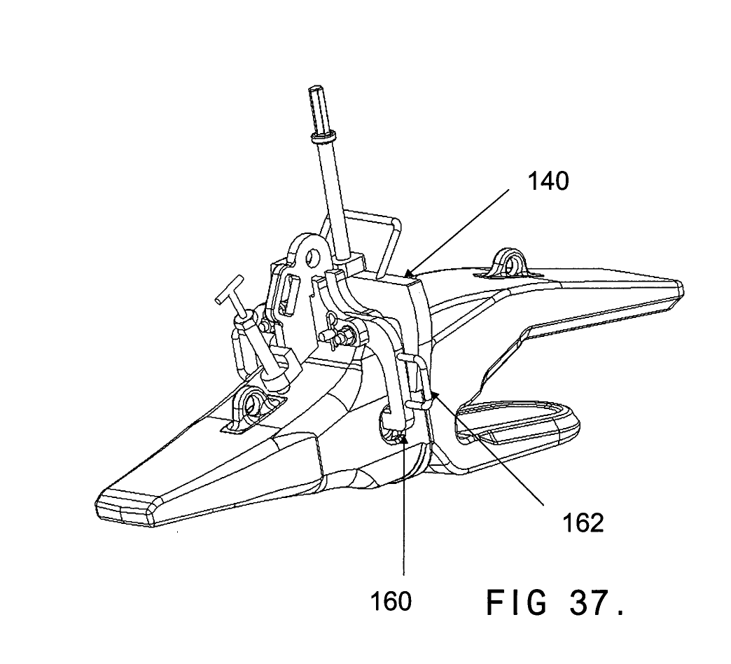

In yet a further alternative embodiment, the point engaging portion may be slightly modified so as to be suitable for use with the disassembly tool 140 illustrated in FIGS. 32 through 35 (i.e. such that the tool and engaging portion are arranged to operate largely independently of one another). One such example arrangement is shown in FIGS. 36 and 37. As illustrated, the engaging portion 160 is simplified and no longer includes the mounting cradle 96 or guide channel 86. Otherwise the features of the engaging portion 160 remain largely unchanged with respect to the FIG. 23 embodiment. In an embodiment handles 162 may be provided on the clamp legs 75 which may eliminate any pinching hazard during movement thereof.

In an alternative embodiment, the disassembly tool 140 may further comprise arms as shown for the tool 90 and the point engaging portion may keep the guide channel 86 such that the point engaging portion retains its ability to capture the disassembly tool once the separation operation has been effected.

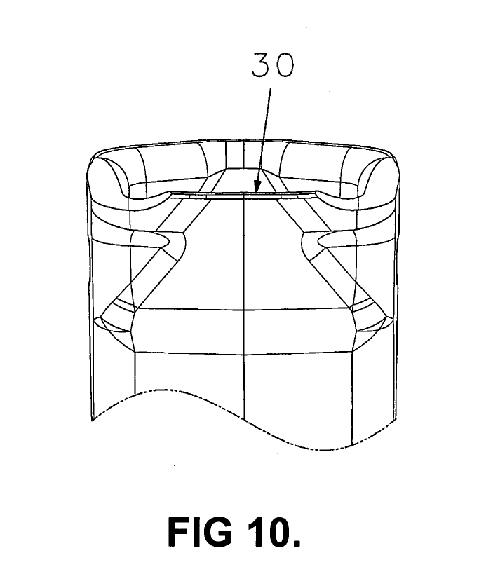

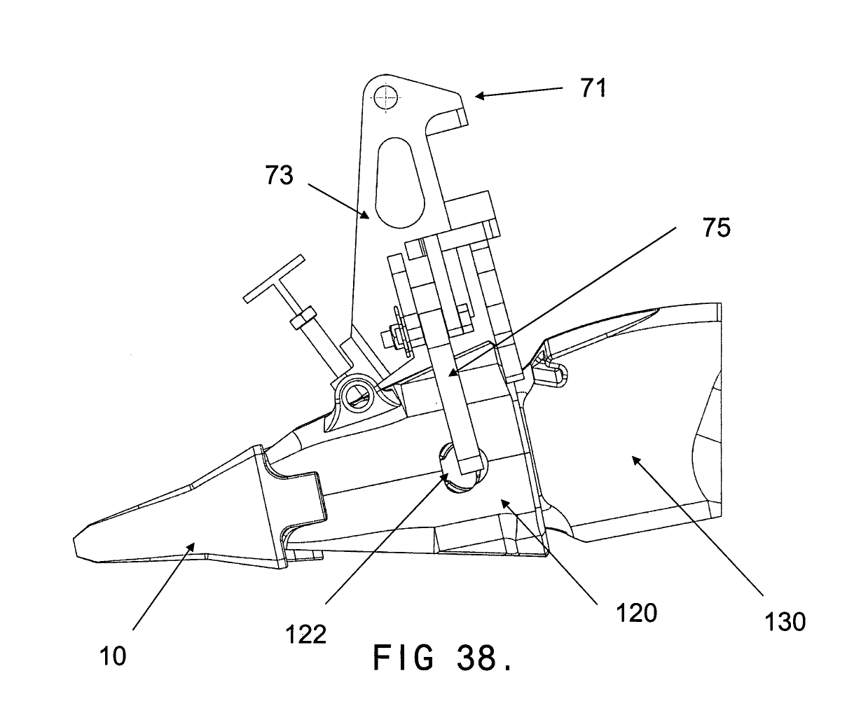

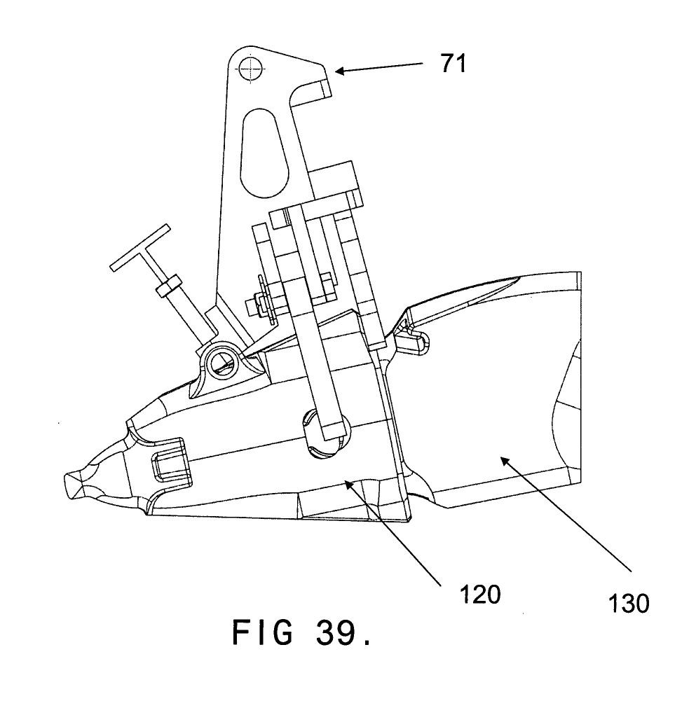

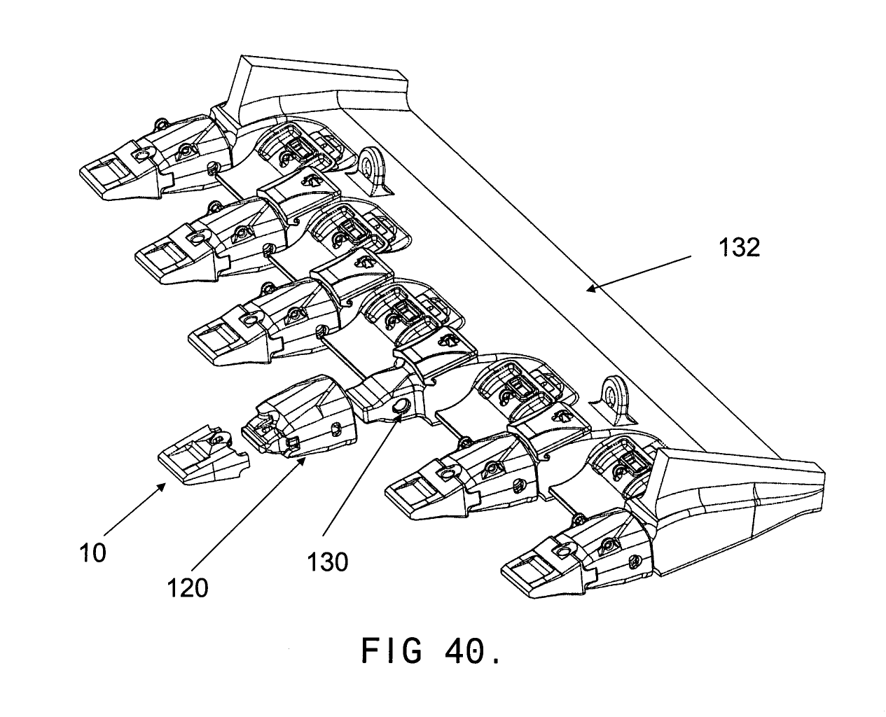

An example embodiment which serves to illustrate operation of a tool with an alternative tooth member assembly is shown in FIGS. 38 to 40 (although it will be understood that any of the hitherto before described tools and/or mounts would be equally suited for affecting separation). According to this embodiment the tooth assembly comprises a mid-adaptor 120 (used to mount a digging point 10) which is coupled to an end adaptor 130 integrally formed on a bucket lip 122 (e.g. cast on the lip). Such a configuration is best shown in FIG. 40 and is commonly found on large scale machines/buckets. As illustrated, the mount 71 comprises the same components as described with reference to FIGS. 23 to 31, but instead of the clamping legs 75a, 75b securing to a cavity in the point 10 they instead secure to a cavity 122 in the mid-adaptor 120 which houses a retaining pin for securing the mid-adaptor 120 to the end adaptor 130. Again, the mid-adaptor 120 and/or end adaptor 130 could comprise a raked profile for cooperating with the tool wedge (i.e. as previously described for the point and adaptor with reference to FIGS. 8 through 12).

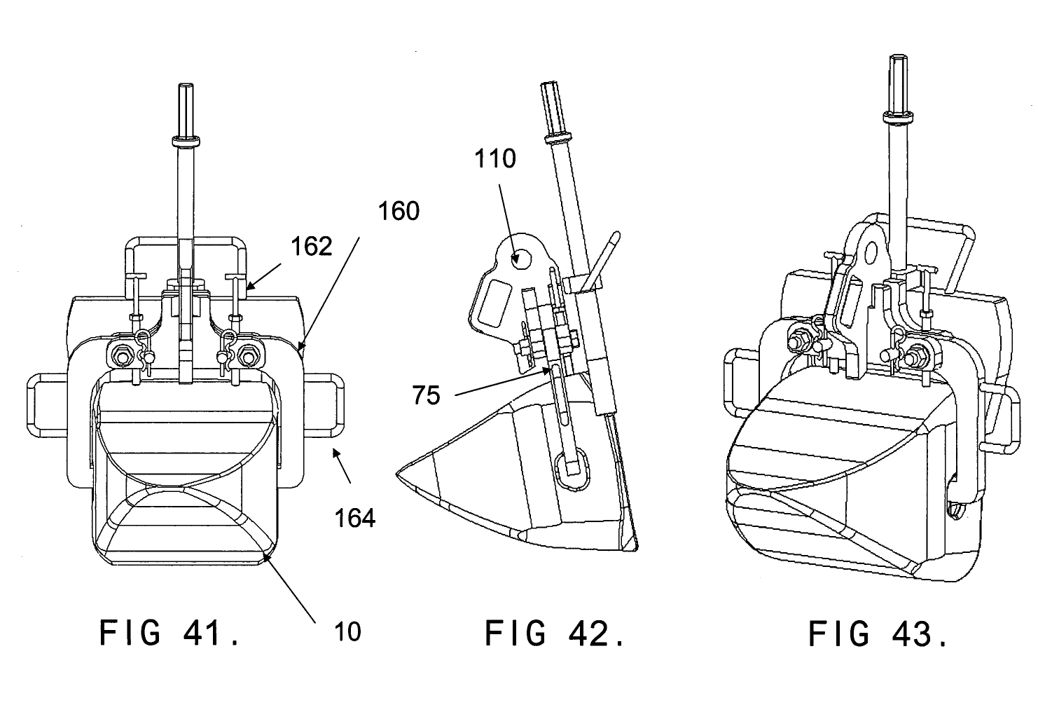

Yet a further embodiment of a mount is shown in FIGS. 41 to 43 (while the mount is shown in association with the tool 140 of FIG. 33, it will be understood that the mount could be used with any of the hitherto before described tool variations, or indeed could be used independently thereof for point removal and replacement). According to this embodiment, the mount 160 comprises a stabilising member coupled to the mounting portion 75 and movable between a retracted position and an abutting position whereby an end of the member abuts a surface of the tooth member for stabilising the tooth member during removal. In the illustrated embodiment, the stabilising member is in the form of a pair of screws 162 threadingly retained by the mounting portion 75 and which can be screwed into engagement with an outer surface of the tooth member adjacent its coupled end (i.e. away from the digging end of the point which can be excessively worn and thus difficult to engage). A handle 164 may be provided to assist with manoeuvring of the mount 160.

Embodiments described above may provide one or more of the following advantages:
Clamp legs which fit into existing tooth member cavities for easy fitment and retention of the tooth member(s) after separation
Increased stability of the mount
Increased safety due to eliminating use of hammers and risk of chipping and flying debris towards operators
Improved safety by utilising a crane/hoist to manoeuvre the point removal apparatus by using a dedicated crane/hoist hole
Brackets which guide and retain separation wedge after disassembly
Reduced assembly/disassembly time with the use of R-Clips to install/remove Bolts.
Improved alignment between parts by way of the adjustment mechanism
Stabilisers which support hydraulic ram during disassembly.

It will be understood that the mounts described above need not be secured to the point but instead could be secured to the adaptor (or other suitable tooth support member) using cavities located thereon.

Furthermore, it will be understood that while operation of the various embodiments of the tool have largely been described with the ramp surfaces facing towards the point (i.e. such that, in use, the ramp surfaces engage a surface of the point collar), the tool could be orientated the other way around such that the ramp surfaces face towards the adaptor body (or other complementary tooth member assembled thereto). This may be advantageous for embodiments where the adaptor has a shoulder portion which is profiled as shown in FIGS. 11 and 12. Equally, it will be understood that the tool could be configured with ramp surfaces on both sides of the wedge shaped body.

It will also be understood that the assembled tooth members could be retained by any suitable locking mechanism and should not be seen as being limited to the particular transverse arrangement described herein.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A tool for disassembling an excavation tooth assembly comprising first and second tooth members, the tool comprising:
a body comprising a driven portion and first and second legs, the legs extending generally in a common plane and defining an assembly receiving cavity therebetween, each of the first and second legs comprising a wedge portion adjacent the assembly receiving cavity which tapers toward a distal end of the respective leg, in use the tool being adapted to locate over a join defined between the first and second tooth members such that the wedge portion of the first and second legs locates within the join and wherein in use a force applied to the driven portion is arranged to drive the wedge portion further into the join so as to cause separation of the first and second tooth members in a direction transverse to the movement of the first and second legs.

2. A tool in accordance with claim 1, wherein the body further comprises a main portion from which the first and second legs depend.

3. A tool in accordance with claim 2, wherein the legs are spaced apart and join with the main portion to form a U-shaped configuration.

4. A tool in accordance with either claim 2 or 3, wherein the legs extend from a lower surface of the main portion and the driven portion is mounted on an upper surface of the main portion opposite the lower surface.

5. A tool in accordance with claim 4, wherein the driven portion comprises a coupling portion adapted to couple to a device for imparting the force.

6. A tool in accordance with claim 5, wherein the driven portion further comprises a shank which extends from the upper surface of the main portion to the coupling portion.

7. A tool in accordance with claim 6, wherein the coupling portion is spaced apart from the main portion such that, in use, movement of the coupling portion in a direction generally perpendicular to an longitudinal axis of the shank causes the wedge portion to impart a lateral force to at least one of the tooth members.

8. A tool in accordance with any one of claims 1 to 4, wherein the driven portion comprises an enlarged head located on the main portion.

9. A tool in accordance with any one of the preceding claims, wherein each of the legs further comprise an outer portion adjacent the wedge shaped portion which is of thicker width that the wedge shaped portion.

10. A method of disassembling an excavation tooth assembly comprising first and second tooth members which are coupled together such a gap is defined at a join between the two assembled members, the method comprising forcing a wedge into the gap in a direction transverse to a longitudinal axis of the excavation tooth assembly so as to cause separation of the first and second tooth members, the separation being generally in the direction of the longitudinal axis of the assembly.

11. A method in accordance with claim 10, wherein the force applied to the wedge is a percussive force.

12. A method in accordance with claim 11, further comprising utilising a jack-hammer or hammer to apply the percussive force.

13. A method in accordance with claim any one of claims 9 to 12, wherein a further gap is located on an opposite side of the join, the method further comprising forcing a second wedge into the further gap in unison with the forcing of the first wedge.

14. An excavation tooth member adapted to be mounted on a body portion of a supporting tooth member, the excavation tooth member having an end structure which at least partially surrounds a cavity in which the body portion of the supporting tooth member fits;
the end structure having a raked portion defining an abutment surface arranged so that an inwardly tapering gap is defined between the abutment surface and a confronting portion of the supporting tooth member; whereby the members may be disassembled by application of a tool having a wedge shaped element which is arranged to be driven into the gap.

15. An excavation tooth support member comprising a body portion adapted to mount a second tooth member, the body portion comprising a shoulder section having a raked portion defining an abutment surface arranged so that an inwardly tapering gap is defined between the abutment surface and a confronting end structure of the second tooth member when in an assembled state; whereby the members may be disassembled by application of a tool having wedge shaped element which is arranged to be driven into the gap.

16. An excavation tooth system comprising first and second excavation tooth members, the first and second tooth members being assembled such that a body portion of the first tooth member is located substantially within a socket defined in a body of the second tooth member, the system further comprising a disassembly tool comprising a wedge portion which is arranged to locate in gap defined at a join between the first and second tooth members, in use the wedge portion of the tool being arranged to be driven into the gap so as to cause separation of the first and second tooth members in a direction transverse to the movement of the wedge portion.

17. An excavation tooth system in accordance with claim 16, wherein the second tooth member at a joining end comprises a end structure which at least partially surrounds the socket and the body portion of the first tooth member includes a shoulder section defined on opposite walls thereof which are closely spaced from the end structure whereby gaps are defined.

18. An excavation tooth system in accordance with claim 17, wherein the disassembly tool is the tool as claimed in any one of claims 1 to 8 and whereby the legs of the tool locate in the respective gaps to affect the separation.

19. An excavation tooth system in accordance with any one of claims 16 to 18, further comprising a force imparting device coupled to the tool which is arranged to impart the force.

20. An excavation tooth system in accordance with claim 19, wherein the force imparting device comprises a jackhammer arranged to impart a percussive force for separating the tooth members.

21. A mount for a disassembly tool for an excavation tooth assembly comprising first and second tooth members, the mount comprising:
a mounting portion arranged to detachably mount to one or both of the first and second tooth members; and
a reaction portion connected to or integrally formed with the mounting portion and arranged in use to be spaced from the first and second tooth members, the reaction portion being arranged to mount a force actuating device which, in use, is arranged to impart a force to the disassembly tool so as to cause separation of the first and second tooth members, wherein the reaction portion is arranged to accommodate the reaction loading induced by the force actuating device.

22. A mount as claimed in claim 21, wherein the reaction loading experienced by the mount as it drives the disassembly tool is resisted by connection of the securing portion to the first and/or second tooth member.

23. A mount as claimed in claim 21 or 22, further comprising a guide portion arranged to guide movement of the disassembly tool under the force imparted by the force actuating device.

24. A mount as claimed in claim 23, wherein the guide portion comprises a channel arranged to receivingly guide an arm coupled to the disassembly tool.

25. A mount in accordance with any one of claims 21 to 24, wherein the mounting portion comprises a pair of clamping legs each having a first end which couples to a body of the apparatus and a second end which locates within a cavity provided on a body of the first and/or second tooth member.

26. A mount in accordance with any one of claims 21 to 25, wherein the force actuating device comprises a hydraulic or pneumatic ram.

27. A mount in accordance with claim 26, wherein the reaction portion comprises a mounting cradle arranged to couple to the disassembly tool and which mounts a body of the ram.

28. A mount in accordance with claim 27, wherein the reaction portion further comprises an abutment structure which is spaced apart from and located in substantially the same plane as the mounting cradle, such that in use an arm of the hydraulic ram bears against the abutment structure to thereby cause the disassembly tool to be driven toward the tooth assembly.

29. A mount in accordance with any one of claims 21 to 28, wherein the apparatus body further comprises a lug arranged to receive a hook of a lifting apparatus.

30. A mount in accordance with any one of claims 21 to 29, further comprising an adjustment mechanism arranged to adjust a retaining angle of the disassembly tool with respect to the tooth assembly for suitably aligning the tool.

31. A mount in accordance with claim 30, wherein the adjustment mechanism comprises an internally threaded housing retaining a bolt, an end of which is in contact with a surface of the first and/or second tooth member such that turning the bolt causes the retaining angle to change.

32. A mount as claimed in claim 21, wherein the mounting portion comprises a lower frame defining a base and upwardly extending arms which project partly into a gap between the first and second tooth members in a bottom region and the reaction portion comprising an upper frame adapted to be connected to the lower frame and providing an abutment structure for receiving one end of a hydraulic ram, the other of which is adapted to be applied to the disassembly tool.

33. A mount as defined in claim 32, wherein at least one of the mounting portion and reaction portion comprises guide arms extending around the frame to guide the tool slidingly along the frame as the tapering structures of the legs are inserted into the gap.

34. A disassembly apparatus comprising a mount as defined by any one of claims 21 to 33 and a tool as defined by any one of claims 1 to 8.

35. An apparatus for disassembling a first excavation tooth member from a second excavation tooth member, the tool comprising:
a body comprising a mounting portion arranged to mount to a body of the mid-adaptor; and
a disassembly tool movably coupled to the body, the tool comprising a driven portion and a separating wedge portion which is arranged to locate in a gap defined between a collar of the mid-adaptor and a neck of the end adaptor, in use the driven portion arranged to receive a force to drive the separating wedge portion into the gap so as to cause separation of the first and second tooth members in a direction transverse to the movement of the separating wedge.

36. An apparatus in accordance with claim 35, wherein the tool is the tool in accordance with any one of claims 1 to 8.

37. A disassembly tool, apparatus, mount and/or method in accordance with any one of the preceding claims, wherein the excavation tooth assembly comprises a combination of two of the following excavation tooth members: a digging point, adaptor, mid-adaptor, end adaptor, plate lip adaptor and cast lip integral nose.

38. A mount for a disassembly tool for an excavation tooth assembly comprising first and second tooth members, the mount comprising:
a mounting portion arranged to detachably mount to one or both of the first and second tooth members; and
a stabilising member coupled to the mounting portion and movable between a retracted position and an abutting position whereby an end of the member abuts a surface of the tooth member to which it is secured for stabilising the tooth member during removal.

39. A mount in accordance with claim 38, wherein the stabilising member comprises a pair of screws threadingly retained by the securing portion and which can be screwed into engagement with an outer surface of the tooth member adjacent its coupled end.
